(19) United States
(12) Patent Application Publication
(10) Pub. No.: US 2023/0365809 A1
(43) Pub. Date: Nov. 16, 2023

(54) PREPARATION OF BITUMEN-CONTAINING ROAD SURFACE MATERIAL

(71) Applicant: WEIBEL AG, Bern (CH)

(72) Inventor: Joël Rossier, Vionnaz (CH)

(73) Assignee: WEIBEL AG, Bern (CH)

(21) Appl. No.: 18/098,896

(22) PCT Filed: Jul. 20, 2021
(86) PCT No.: PCT/EP2021/070281

§ 371 Date: Jan. 19, 2023

(30) Foreign Application Priority Data
Jul. 20, 2020 (CH) 00896/20
Feb. 15, 2021 (CH) 00145/21

(51) Int. Cl. C08L 95/00; C08K 5/14; C08K 3/26

(52) U.S. Cl. CPC C08L 95/00; C08K 5/14; C08K 3/26; C08L 2555/20; C08L 2555/34; C08L 2555/84; C08L 2207/22

(57) ABSTRACT

The present disclosure sets out a method for processing bituminous road surfacing material from a road demolition. The bituminous road surfacing material is in the form of break out material and/or milled material. The following steps are carried out as part of the method: mixing the bituminous road surfacing material with water to form a mixture and adding a peroxide and/or a bicarbonate to the water and/or the mixture, in particular hydrogen peroxide and/or a bicarbonate.

### CROSS REFERENCE TO RELATED APPLICATIONS

This application is a national phase application of International Application No.: PCT/EP2021/070281, filed Jul. 20, 2021, and claims the priority benefit of Swiss patent applications 00896/20 and 00145/21, filed on Jul. 20, 2020 and 02/15/2021, respectively; the content of the aforementioned being incorporated herein by reference.

### BACKGROUND OF THE INVENTION

### Field of the Invention

The present disclosure relates to methods for processing bituminous road surfacing material from a road demolition, wherein the bituminous road surfacing material is in the form of demolition material and/or milled material.

### Description of the Related Art

For more than a century, roads have been covered with a bituminous road surface. The bituminous road pavement typically consists of a top surface course, which forms the road surface, a binder course, a base course and a foundation course. The lower layers, especially the foundation layer, do not necessarily have to include bituminous material. The bituminous road surface includes, among other things, bituminous material, grit, sand, fillers and binders, respectively.

Bitumen is a by-product of petroleum distillation. It can be assumed that if the demand for fuels decreases due to the booming alternative propulsion systems (electric, hydrogen, etc.), the production of bitumen will also decrease. Thus, in addition to the economic and ecological aspects, methods for recovering the bituminous material will also gain relevance in the future.

Road bitumen, roofing felt and similar building materials based on bitumen are produced from residues of crude oil after atmospheric distillation and/or cracking.

Road bitumen are standardized and are classified according to their properties (e.g. needle penetration or similar). Based on these properties, an ideal construction material can be selected for different climatic conditions. To produce the road pavement, the road bitumen is heated to 120 to 230° C. and added to the granules, sand, especially crushed sand, grit and filler in a proportion of 5 to 7% by weight. Granules, sand and filler are preheated to 150 to 400° C. to expel residual water. The mass is then rolled to form a very resistant coating, which contains practically no water. These coatings are therefore insoluble in water and very resistant. The parameters of production as well as the composition of the asphalt pavement can vary.

Over time, the surface layer wears out; the granules on the surface become rounded or even flattened due to wear, making the surface layer slippery. In addition, ruts form over time. In this case, the road must be renovated by removing a few centimeters of the surface layer by milling and then applying a new surface layer. If the road needs to be completely renovated, the entire pavement is broken out and then the road is rebuilt.

The product resulting from the breakout or milling of bituminous road pavements is in the form of bituminous conglomerate, which typically has a grain size (mesh size in sieve analysis) of more than 5 cm. In the case of break out material, the fragments can be several decimeters in size and weigh up to 20 kg or more.

Direct recycling by adding a portion of the removed bituminous pavement material to the new pavement is not possible in every application, especially when higher demands are made on the quality of the asphalt pavement. If necessary, the quality of the road pavement material can be improved by adding juvenators, so that the road pavement material can be used again afterwards. Typically, the juvenators thus reduce the viscosity of the bitumen. With the penetration test, the addition of juvenators can be controlled—the higher the proportion of juvenators, the higher the penetration value (penetration value means the result of the fulling penetration according to DIN ISO 2137; 2016-12, which has the unit 0.10 mm). However, such road pavements have a reduced quality and service life compared to the road pavements produced from the raw materials (bitumen and aggregate), especially since the aggregate, which is subject to wear, is not replaced.

A major problem in the recycling of road pavement material is the strong bonding of the bituminous material within itself and to the rock. This is due to the fact that the road surfacing material is manufactured to be as robust as possible through the choice of rock, bitumen and the use of a variety of aggregates—after all, the goal in the manufacture of road surfacing is to achieve the longest possible service life. With the targeted selection of the base materials and the aggregates, maximum adhesion is created between the bitumen and the rock. On the one hand, this creates a highly resilient road surface, but on the other hand, it also makes it as difficult as possible to separate the bituminous material from the rock.

This is exemplified by the “Determination of the adhesion of bituminous binders to mineral aggregates” according to SN 670 460 (Swiss standard, as of 2012) and EN 12697-11 (European standard). In this test, bitumen is added to rock with a diameter of 8/11 mm and then immersed in water for 24 hours. The degree of coverage of the rock is then determined. Typical results show that with untreated bitumen a degree of coverage of about 65% can be achieved, while with the addition of binder a much higher degree of coverage can be achieved, in particular of more than 85%. Thus, the addition of binder achieves a significantly higher bond between the bitumen and the rock than is possible, for example, with naturally occurring bitumen.

However, it is not only these factors that make it difficult to separate bituminous material from rock in bituminous road surfacing material. Other factors are due to the production process and the aging process of the road pavement material.

The reasons for this have been investigated by various studies. One of these studies was conducted by Fand Ben Salem under the title “Évaluation de l'effet d'ajout du régénérant sur le bitume vielli et sur les enrobés recyclés a froid” (École de Technologie supërieure Université du Québec; Montréal, le 2 Mars 2017). According to this study, bitumen aging is one of the biggest problems in asphalt recycling. Aging leads to a change in the chemical structure of the bitumen and to higher viscosity and stiffness.

In the manufacturing process, the bituminous road pavement material is exposed to high temperatures, typically in excess of 150° C. This results, on the one hand, in volatile constituents becoming more volatile. On the one hand, this causes volatile constituents to evaporate, and on the other hand, the bitumen is oxidized. The high temperature has a considerable influence, since a temperature increase of 10-12° C. can double the volatilization of the fractions with lower molar mass. Thus, the aging process already takes place to a considerable extent during the production of the road pavement. The evaporation of the volatile components (VOC) cannot be neglected and can cause a mass loss of several percent in the bitumen during the manufacturing process. The penetration value thus already decreases considerably during the production of the road pavement, typically from 60-100 to around 20 (10⁻¹ mm).

Bituminous road pavements are further exposed in the aging process over decades to the weather, such as sun and thus in particular UV radiation, rain, temperature fluctuations and last but not least traffic loads. Essentially, curing of the road pavement occurs through volatilization of the light fractions and oxidation (internal and caused by solar radiation).

Oxidative aging occurs due to the diffusion of atmospheric oxygen through the structure of the asphalt, thus changing the viscoelastic properties of the bitumen. This leads to an increase in the overall stiffness of the bituminous road pavement material. This phenomenon occurs with all types of bituminous material.

A further complicating factor is the fact that the bituminous conglomerate comprises relatively large fragments after the road has been broken out or milled. These typically have to pass through an elaborate crushing process, for example a crusher. On the one hand, this process is very expensive, and on the other hand, it crushes the rock and thus reduces its quality. It also generates a lot of dust, which in turn affects the quality of the bitumen.

Despite the difficult initial situation, attempts have been made to separate the bituminous material from the rock. For example, a process is known by which the bituminous material is separated from the rock by adding organic solvents to the road surfacing material and extracting the bituminous material. This process has the disadvantage that large quantities of organic solvents must be used in order to implement it on an industrial scale. Such processes are also questionable for ecological reasons.

So far, however, the search for an efficient process for the treatment of road pavement material that does not require organic solvents has been unsuccessful. Due to the low VOC content in particular, this places special demands on the technology, since the extensive absence of volatile organic molecules means that there is a lack of solubilizers that could support the separation of the bituminous material from the aggregate. For these reasons, bituminous road surfacing material has so far mostly been disposed of at great expense.

### BRIEF SUMMARY OF THE INVENTION

It is an object of the presently disclosed invention to create a process belonging to the technical field initially mentioned, by means of which bituminous road surfacing material from a road demolition in the form of break out material and/or milled material can be processed simply and cost-efficiently.

Accordingly, for processing bituminous road surfacing material from a road demolition in the form of break out material and/or milled material is mixed with water to form a mixture. A peroxide and/or a bicarbonate, in particular hydrogen peroxide and/or a bicarbonate, are added to the water and/or the mixture.

Surprisingly, it has been shown that despite the difficult conditions due to the high viscosity and low penetration values, respectively, as well as the addition of binders, etc., the conglomerates can be disintegrated by means of a particularly simple and cost-efficient variant without having to use a crusher or the like. By using the peroxide and/or the bicarbonate, preferably in warm water and under contact, the cohesion of the conglomerates is loosened in a surprising way, thus achieving a disaggregation of the conglomerates. This results in several advantages in the process of processing bituminous road surfacing material:
1. As there is no need for a crusher or similar equipment, the process is particularly cost-effective.
2. The fact that the disaggregation takes place in water avoids the occurrence of harmful dusts and the like.
3. The fact that the disaggregation takes place in water with the addition of a peroxide and/or a bicarbonate creates a particularly economical process in terms of energy.
4. The fact that the disaggregation takes place by adding a peroxide and/or a bicarbonate results in a particularly gentle disaggregation of the demolition material and/or the milled material. In particular, this prevents grinding/crushing of the gravel, which means that the quality of the gravel can be maintained during the process for processing the bituminous road surfacing material.
5. A separation process for separating the bituminous material from the grit can be carried out in the same process step. Thus, a separation process in which the bituminous material is separated from the grit and, at least partially, from the sand and filler can be carried out in a single reactor. This results in a particularly small space requirement for the process for treating the bituminous road surfacing material, provided that the bituminous material is also to be separated from the grit after disaggregation.

In summary, it can be stated that according to the invention a process has been found in which road surfacing material from road demolition can be mixed with water without intermediate processing and disaggregated by the addition of peroxide and/or a bicarbonate. The disaggregated bituminous road pavement material can then either be added directly to a new road pavement material or, in a further step, completely recycled.

The bituminous road surfacing material originates from road demolition. Thus, it preferably comprises bitumen, which is the heaviest fraction produced by the oil refinery. However, as described above, substances such as binders etc. are added to the bitumen during the production of the road surfacing material in order to improve adhesion to the gravel. Furthermore, substances are also removed from the bitumen, in particular during production by the heating process—many volatile substances (e.g. with an evaporation temperature of 150° C.) are removed in the process. But also in use as a road surface—which, depending on the load, lasts for decades—further volatile substances are removed by the weather. Thus, the road surfacing material from road demolition is a secondary raw material with specific properties.

On the other hand, it is well known that different road surfacing materials differ in terms of the bitumen used, the aggregates, etc. For the present process, such variations are not relevant. For the present process, such variations are essentially irrelevant; the process works with at least 90% of the known bituminous road surfacing materials, in particular the bituminous road surfacing materials comprising grit, sand and filler.

Thus, prior to the process for the preparation of bituminous road surfacing material, in a first step a road surfacing material is produced from bitumen, grit, sand and filler as well as typically binders. This is rolled in a second step to form a road surface. At a later stage (preferably after more than 10 years), the bituminous pavement material is demolished from the road. The bituminous road surfacing material preferably includes the bituminous layers of the road's superstructure, typically the surface course, the binder course, the base course and, if necessary, the foundation course of asphalted roads. During road rehabilitation, the road surface is either completely demolished (surface layer together with one or more base layers) or the surface layer (at least the asphalt surface course, if necessary, additionally the binder layer) is milled off. In the following, road pavement material is understood to mean both the breakout material and the milled material. In a third step, fed to the present method for processing, with the primary objective of disaggregating the conglomerates from the breakout material and/or the milled material. A secondary objective includes at least the separation of the bitumen from the grit and preferably further from the sand and filler.

By using the peroxide and/or the bicarbonate, a reaction can be produced that reduces the adhesion force between the bituminous material and the matrix, whereby a separation of the conglomerate can be achieved. Further, separation of the bituminous material from the grit and possibly from sand and filler can be achieved. Secondary effects of the reaction (heat generation, bubble formation, etc.) also lead to better separation of the bituminous material from the grit. Furthermore, components of the matrix to which the bituminous material adheres (grit, sand, filler, etc.) could also be attacked or dissolved by a chemical and/or physical reaction.

In a particularly preferred embodiment of the process, either a peroxide or a bicarbonate is used. In variants, however, the peroxide can also be used together with the bicarbonate.

The peroxide may in principle be present as any peroxide. However, hydrogen peroxide is particularly preferred since it decomposes only to water and oxygen and thus does not contaminate the process water in particular.

The bicarbonate can in principle be present in various forms, but preferably as sodium hydrogen carbonate.

In addition to the peroxide and/or the bicarbonate, however, other substances can also be added to optimize the process—but these are not absolutely necessary for the process, since surprisingly this already works well with peroxide and with bicarbonate, respectively.

The addition of the hydrogen peroxide and/or the bicarbonate is preferably controlled in such a way that conglomerates of the bituminous road surfacing material are disaggregated. On the one hand, the concentration of the hydrogen peroxide as well as the addition rate and, on the other hand, the total time span of the process are preferably controlled accordingly. Particularly preferably, at the beginning of the process, the hydrogen peroxide and/or the bicarbonate are added continuously over a first period of time and, in a second period of time following the first period of time, no hydrogen peroxide and/or the bicarbonate are added. Thus, preferably after the addition of the hydrogen peroxide and/or the bicarbonate, the reaction mixture is allowed to react for a second period of time. In this way, bituminous road surfacing material in the form of demolition material and/or milled material can be disaggregated in a particularly efficient, cost-effective and essentially emission-free manner.

In variants, the process can also be carried out only until the conglomerates have fallen below a certain limit size—this depends on the further use of the conglomerates. Particularly preferably, however, the process is continued even after the bituminous road pavement material has been completely disaggregated. Indeed, it was found—also surprisingly—that if the process is continued, separation of the bituminous material from the grit occurs.

Preferably, the hydrogen peroxide and/or the bicarbonate are added below level. By adding below level, it is achieved that the gas bubbles are generated within the mixture and thus can achieve the best possible separation effect by their rising in the mixture. Therefore, the first outlet is preferably provided near the bottom of the vessel. Studies have shown that the gas bubbles generated by the hydrogen peroxide are particularly small during an initial period after their generation (so-called nanobubbles). These nanobubbles exhibit a very high internal pressure in the water during generation, which can be greater than 3 bar, up to 10 bar or more. This promotes the physiomechanical separation of the bitumen and the minerals, especially since the nanobubbles can penetrate very effectively into the smallest pores/channels of the conglomerate and thus disaggregate or separate them. But also after disaggregation, the nanobubbles can penetrate into pores/channels between the grit and the bitumen and thus, if the process is continued, cause a separation of the bituminous material from the grit and in particular from sand and filler.

The addition of the hydrogen peroxide and/or the bicarbonate can be guided into the mixture, for example, via a pipe guide. The pipe guide may be guided within the mixture so that an outer wall of the pipe is in contact with the mixture. In a particular embodiment, the tube may be connected to an agitator, for example, so that the hydrogen peroxide and/or the bicarbonate are guided along an agitator arm or shaft. In particular, the tube itself may also be designed as an agitator shaft. In further variants, the tube opens from the outside into a vessel bottom or a side wall of the reactor, whereby the hydrogen peroxide and/or the bicarbonate can be guided into the mixture from below or laterally.

In variants, the hydrogen peroxide and/or the bicarbonate can also be added to the mixture above level.

To prevent backflow in the tube, the tube may be equipped with a check valve.

However, this can also be dispensed with.

Particularly preferably, the hydrogen peroxide and/or the bicarbonate are added to the mixture as an aqueous solution. In special variants, the bicarbonate in particular can also be added as a solid.

To force the decomposition of the hydrogen peroxide, a catalyst such as FeCl₃ can be used. Further, the temperature of the mixture or the hydrogen peroxide in the region of the inlet can be heated locally instead. In variants, the catalyst can also be dispensed with, especially if the process water and/or the road surfacing material already comprises corresponding substances.

In order to exploit the effect of disaggregation as fully as possible, the bituminous road surfacing material is preferably mixed directly with water to form a mixture after the road has been demolished and thus fed into the method according to the invention. The bituminous road surfacing material is thus fed unprocessed as break out material and/or milled material into the reactor after road demolition and mixed with water to form a mixture. This creates a particularly efficient method, since no intermediate steps such as crushing, pre-cleaning, separation, etc. are required between the road demolition and the method for processing the bituminous road pavement material.

In variants, however, intermediate steps such as separation according to fragment size can still be provided, especially in the case of road demolition material—even if all fragments are fed to the same process, it can be advantageous to treat very large fragments in a separate reactor due to a possible longer retention time until disaggregation.

The mixture is preferably heated, in particular to a temperature above 50° C. especially preferably above 60° C. The increased temperature accelerates chemical reactions, thus reducing the time required for the process. In particular, at temperatures in the range and above 60° C., an ideal balance between energy expenditure and time expenditure could be found, so that a temperature lower than 90° C. is particularly preferred, preferably lower than 80° C. and especially preferably lower than 70° C.

In variants, the process can also be carried out below 50° C., in particular at, for example, 40° C. or even room temperature. In such a case, it may be advantageous to use a catalyst to assist the process of disaggregation or separation of the bituminous material from the grit by the peroxide and/or the bicarbonate. Further, the process may be carried out at above 90° C.

Preferably, the bituminous road surfacing material comprises grit, sand, filler and bituminous material, wherein the process is carried out until at least 80%, preferably at least 90% more preferably at least 95% of the grit are separated from the bituminous road surfacing material. The recovered grit and sand can in turn be used for use in a road surfacing. In variants, the process can also be stopped when less than 80% of the grit have been separated from the bituminous road surfacing material.

Preferably, the process is carried out until a residual amount of bituminous material adhering to the grit is less than 3% by weight, preferably less than 1% by weight, more preferably less than 0.3% by weight. This results in a particularly cleanly cleaned grit, which can be directly reused in the production of asphalt, in particular without additional cleaning. In variants, the residual amount can also be higher than 1 wt. %.

Preferably, the bituminous material is collected at a liquid surface of the mixture, in particular by means of flotation. This has the advantage that the bituminous material can be removed from the mixture particularly easily, in particular by skimming, decanting, etc. Different techniques exist which can favor the accumulation of the bituminous material at the liquid surface, in particular, for example, by choosing a liquid with high density. However, it is not essential that the liquid have a higher density than the bituminous material.

In variants, the bitumen-containing material can also be trapped in the liquid, for example by filters, adsorption materials or the like. Further, the bituminous material may be discharged at a container bottom, particularly if, for example, the bituminous material has a higher density than the liquid. Further, the bituminous material can also be separated from the sediments and rocks via a centrifuge or grinding.

Preferably, the bituminous road surfacing material comprises at least partially bituminous material having a penetration value of less than 25 10⁻¹ mm, preferably less than 20 10⁻¹ mm, more preferably less than 15 10⁻¹ mm. Particularly preferably, the bituminous material has a penetration value (needle penetration at 25° C.) of less than 5 10⁻¹ mm, preferably less than 3 10⁻¹ mm, in particular less than 1 10⁻¹ mm. The penetration value of the bituminous material in a road pavement typically decreases with increasing age. In variants, a penetration of the bituminous material can also be more than 25 10⁻¹ mm.

Preferably, at least 30 wt. %, preferably at least 50 wt. %, in particular at least 75 wt. % of the bituminous road surfacing material has a conglomerate size of more than 5 cm when mixed with the water. This allows particularly large fragments to be used in the process, which in particular are not subject to any pretreatment. The conglomerates are preferably fed into the process directly after demolition of the road. The size of the conglomerate can be selected to be considerably larger, and in particular, broken pieces of bituminous road surfacing material with a largest diameter of more than 10 cm, in particular more than 20 cm, and especially preferably more than 40 cm, can also be used.

In variants, smaller conglomerate sizes can also be used. The difficulty of the process is basically that even large fragments can pass through the process without pretreatment. In principle, the process will be somewhat faster if the fragments are smaller—but this requires complex crushing or abrasion processes, which would have to precede the present process for preparation.

Preferably, a difference in density between the bituminous material floating on the surface and the mixture is increased by adding at least one first substance influencing the density, the first substance comprising in particular an alkali, an acid, a salt and/or constituents from road surfacing material. By increasing the density difference, the buoyancy of the bituminous material after separation from the matrix can be increased, allowing the bituminous material to reach the liquid surface more quickly. This in turn makes the separation process more efficient and faster to perform.

In variants, addition of the first substance can also be dispensed with.

Preferably, the density-influencing first substance comprises a water-soluble first substance, in particular an alkali or an acid such as, for example, sodium hydroxide solution (NaOH) or a salt, preferably sodium chloride, magnesium chloride, calcium chloride, potassium chloride, sodium carbonate, sodium nitrate, sugars such as polysaccharides, glucose, fructose, sucrose, suspended solids (e.g. fillers) etc. or a mixture thereof, or a water-soluble liquid, in particular a water-soluble polyol such as glycerol, which is added directly or indirectly to the mixture.

The use of salts or sugars has the advantage that they typically have good solubility in water. The salts, in particular alkali and alkaline earth halides, are particularly inexpensive and at the same time readily soluble in water and environmentally compatible. Carbonates and nitrates also exhibit good solubility in water. The carbonates, in particular sodium carbonate, have the advantage of being chloride-free and nitrate-free, and are therefore particularly environmentally compatible. Other salts are known to the skilled person which are also sufficiently soluble or suspendable in water and can thus serve to increase the density. Other possibilities are the polyols, which are typically miscible with water in any ratio and can therefore also be used. Of the polyols, glycerin is particularly preferable, as this is both especially inexpensive and non-toxic.

Preferably, the bituminous road surfacing material comprises binders for achieving a bond between the bituminous material and the gravel, the binders comprising in particular polymers, preferably styrene-butadiene-styrene, amide esters and/or cellulose fibers. This achieves a particularly strong bond between the gravel and the bitumen-containing material. Other binders are also known to the skilled person which can improve a bond between gravel and bituminous material. Surprisingly, it was found that the process for preparing the bituminous road pavement material is only insignificantly influenced by the binders.

However, the process can also be carried out with bituminous road surfacing material that does not contain any additives of binders, typically the process should be faster in these cases respectively with less peroxide and/or bicarbonate.

Preferably, an adhesion between the bituminous material and the gravel of the bituminous road pavement material is between 70% and 80%. Thus, at least 70% to 80% of the surface of the gravel is covered with bituminous material. Again, surprisingly, it was found that the process works essentially independently of the degree of coverage of the gravel by bituminous material.

In variants, bituminous road surfacing material can also be used that has a lower degree of coverage, particularly less than 70%. In these cases, too, the process is likely to be faster, respectively, with less peroxide and/or bicarbonate.

Preferably, the VOC content in the bituminous material is less than 1% by weight, preferably less than 0.5% by weight, and more preferably less than 0.1% by weight. Surprisingly, it was again demonstrated that even with very small proportions of VOCs or volatile organic compounds, the process for processing bituminous road surfacing material works very well. In variants, however, the VOC content can also exceed 1 wt. % without negatively affecting the process.

Based on general knowledge, it was generally expected that due to the high adhesion of the bituminous material to the gravel, respectively due to the addition of binder, the expulsion of VOC (no matter if during the production of the road pavement or during the aging process) a separation process in an aqueous environment is not possible or not sufficiently efficient. Despite the adverse conditions, it has now surprisingly been possible to disaggregate conglomerates of bituminous road surfacing material in an aqueous environment and then, by the same process, i.e. preferably by further addition of peroxide and/or bicarbonate, to separate the bituminous material from the grit.

In a further process, a bituminous secondary raw material is mixed with a liquid to form a mixture, whereupon at least part of the bituminous material is separated from the matrix. This allows the bituminous material and minerals to be recovered and reused in a simple manner. The bituminous material can, for example, be used again in the manufacture of products from which the secondary raw material was obtained. The advantage of using the bituminous material in the same application from which the secondary raw material originates is that residual materials in the bituminous material do not have to be isolated from the bituminous material, or do not have to be isolated completely.

The term “secondary raw material” refers to material that has already been technically used once and is now to be technically used a second time through processing.

The liquid is used to ensure that after the bituminous material has been detached, it can be removed efficiently. The use of the liquid may also have the advantage that it can penetrate between the matrix and the bituminous material and support the separation process. Further, the liquid, depending on its polarity, may also be used to dissolve foreign substances of the matrix and/or the bituminous material.

In a preferred embodiment, however, the liquid comprises at least a major portion which is polar or consists of a polar liquid. This has the advantage that the non-polar bitumen-containing material just does not dissolve in the polar liquid, so that the bitumen-containing material can be separated from the liquid particularly easily, in particular economically. This means, for example, that time-consuming distillation or extraction can be dispensed with. In principle, the separation can be carried out by known methods, e.g. filtering, skimming, milling, etc.

Preferably, the bituminous secondary raw material comprises bituminous road surfacing material, a bituminous road surfacing concentrate produced from bituminous road surfacing material, in particular by a mechanical concentration process, especially preferably by an abrasion process, and/or bituminous roofing felt.

In the present case, the secondary raw material comprises in particular the bituminous road surfacing materials obtained during road renovation.

It is known to recover grit, sand and filler from the bituminous road surfacing material using the so-called abrasion process (dry or wet). With the abrasion process, the bituminous material is rubbed off from the grit, sand and filler, whereby on the one hand the grit, sand and filler and on the other hand the abrasion (a bituminous road surfacing concentrate in which the bituminous material is concentrated by a mechanical process) are recovered—this process is known to the skilled person. The grit, sand and filler can be used again for the production of road pavements, if necessary, after screen separation. Up to now, the abrasion obtained by the abrasion process has been disposed of. The abrasion contains a larger proportion of bituminous material than the breakout material or the milled material and is therefore particularly suitable for the present process, especially since a smaller container volume can be used for the same yield of bituminous material, which in turn means that less liquid has to be used and energy consumption can be reduced accordingly (possible heating, stirring, etc.). The abrasion is also subsumed under the term road surfacing material. However, the present process is especially suitable for separating bituminous material from break out material and milled material from road surfacing materials. These two materials represent a particular challenge for the separation into bituminous material and matrix, since on the one hand the fragments or the grain size are relatively large and on the other hand the content of bituminous material is correspondingly lower than in the case of abrasion. In this sense, abrasion places lower demands on the process.

In the abrasion process, grit and sand may not be sufficiently or completely freed from the bituminous material, in particular, concave areas of the grains, for example, cannot be freed from the bituminous material. The grit and sand, which are present after the abrasion process, are also subsumed under the term secondary raw material and can thus also be subjected to the present process. In this way, grit and sand with greater purity can be obtained. In variants, the grit and sand can also be directly reused after the abrasion process.

It is clear to the skilled person that other bituminous road surfacing concentrates can also be used in the process as secondary raw materials. Concentration of the bituminous material can also be achieved via the present process itself, which can be equivalent to running the process several times. In this case, however, the parameters (additives, temperature, etc.) may differ.

Specifically, the road surfacing materials may include asphalt base courses, asphalt binder courses, asphalt concrete, stone mastic asphalt, mastic asphalt, porous asphalts, SAMI layers, as well as asphalt surface treatments of road pavements etc.

Further, the secondary raw material may also include roofing felt. Roofing felt or tar paper is a bitumen-impregnated paperboard that serves as a moisture barrier, for example, as an underlayment under roofing tiles. The roofing felt can include coarse-grained sand, fine gravel or slate chips, which provides a higher abrasion resistance or UV resistance. Furthermore, the secondary raw material can also include other bituminous building materials, in addition to the road surfacing materials and the roofing felt, namely, for example, sealing membranes, insulations, adhesive masses, impregnating masses, sealing compounds, etc.

The process can further be used to decontaminate soils contaminated with apolar substances. The soils can be, for example, soil horizons below the H, L and O soil horizons (organic soil horizons), preferably, for example, A horizons, B horizons, C horizons and others. For example, the process can be used to decontaminate soil material from a contaminated industrial site. Furthermore, the process can be used to decontaminate soil after an environmental disaster. For example, the process can be used to decontaminate beach soils after an oil tanker accident. Further, the process can be used to clean up soil contaminated with motor oil in traffic accidents. Furthermore, the process can be used to clean minerals in road drainage shafts from engine oil.

With this process, for example, PAHs (polycyclic aromatic hydrocarbons), fibers, particles and other additives such as mineral additives (for example basalt), metallic additives or plastic additives (aramid etc.), which may be present in asphalt mixtures from old roads, can be removed particularly effectively and safely. This process can further be used for the separation of metals in the context of cleaning waste, such as combustion residues like slag and flue ash.

Further, this process can also be used to remove bituminous or oily residues from sand, for example in the context of cleaning the sand of a beach to deal with ecological disasters, for example caused by vehicle accidents (car accidents, truck accidents, aircraft accidents, ship accidents, etc.).

Other bituminous secondary raw materials are also known to the skilled person, in which the bituminous material can be at least partially separated by means of the process.

Preferably, the liquid is water. This means that a polar, inexpensive, non-toxic and easy-to-prepare liquid is selected for the process, which means that the process can be carried out particularly economically. Furthermore, water has a particularly high surface tension, which means that a separating layer of the floating bituminous material can be kept particularly stable.

In variants, other liquids can also be used, in particular, for example, phenol, cresol, liquid sulfur dioxide, nitrobenzene, aniline, toluidine, nitrotoluene, crotonaldehyde, acrolein, dichloroethyl ether, furfural, ethylaniline, dichlorobenzene or mixtures of the aforementioned liquids with or without the addition of benzene. Other organic solvents such as alcohols, polyols such as glycerol, oils, acids, bases or mixtures of the above-mentioned liquids are known to the skilled person and can be used for this purpose. However, the organic solvents have the disadvantage that an economical as well as ecological separation process can hardly be achieved with them. For small quantities, however, the process can be carried out particularly efficiently.

Furthermore, it is also possible to use a supercritical gas, in particular supercritical CO₂ due to its apolar property, for the separation of bituminous material from the matrix.

In a preferred method, the liquid is prepared after the separation process and used again for a separation process. In this case, it is not necessary to separate the first substance during the preparation of the liquid since the increased density can also be used in a subsequent process for separating bituminous material from a matrix. The liquid can also be used directly again for the separation process without preparation. In this case, a smaller addition of additives to increase the density can be provided or dispensed with, in particular since, for example, suspended solids such as filler, sludge or other additives which were added to the liquid in earlier separation processes and are therefore still present in the liquid, whereby the density may already have been sufficiently increased.

In variants, the additives for increasing the density can also be dispensed with. Experiments have shown that in particular in a process in which the secondary raw material has previously been subjected to an abrasion process, the first substance can be dispensed with, especially from an economic and ecological point of view—it is clear to the skilled person that the first substance can nevertheless benefit the process. Further, other substances can be added to increase the density. Many other possibilities are known to the skilled person for this purpose.

Furthermore, if necessary, the additives for increasing the density can be dispensed with if the temperature of the mixture is heated to more than 35° C., since above a limit temperature of 35° C. the density of bitumen is lower than that of water. (It should be noted that, depending on the bitumen grade, the limit temperature can also be lower or higher). At temperatures below 35° C., either additives can be added to increase the density or the bitumen can be separated by other techniques. However, even at temperatures above 35° C., the addition of density enhancing additives can be helpful to increase the density difference between the bitumen and the liquid, thus accelerating bitumen buoyancy and the separation process.

Increasing the water density can also be omitted. In this case, the bitumen can be precipitated. For precipitation of the bitumen, a lower temperature is particularly advantageous (below 35° C.), since in this temperature range the density of bitumen is greater than the density of water. The separation of the bitumen and the mineral material can be done, for example, by means of a selective screw that only picks up stones and sand. Further, the bitumen can be scraped off the bottom of the reactor continuously or discontinuously.

Provided that the bitumen is kept in suspension due to a small density difference with the liquid, or despite a higher density due to an agitator, the suspension can be passed through a separator in a continuous process to separate the bitumen, and the liquid can be returned to the process. The separator may include, for example, an aspirator or a decanting device.

Another option is to treat the liquid with a cyclone during processing and remove the bitumen in suspension through a pumping and water separation process (e.g., cyclone, filter). The separated liquid can be added back to the reactor, if necessary.

Preferably, the density-influencing first substance comprises a non-polar first substance having a lower density than the bituminous material, wherein the non-polar first substance is added to the bituminous material. In this way, the density of the bituminous material floating up can be reduced, whereby sinking into the liquid can be counteracted. Such non-polar substances are known to the skilled person in a variety of ways. For example, gases such as air, CO₂, low molecular weight aliphatic hydrocarbons such as propane, butane can be used. In principle, any petroleum fractions can be added which have a lower density than that of the bitumen. In the process, a film or liquid layer can be formed on the liquid surface with the non-polar first substance, whereby rising bituminous material dissolves in the non-polar first substance and thus cannot sink again.

In variants, the non-polar first substance can also be dispensed with.

Preferably, adding at least one second substance generates a chemical and/or physical reaction in the mixture. With a suitable reaction, the adhesion force between the bitumen-containing material and the matrix can be reduced, whereby the separation process can be optimized. Secondary effects of the reaction (heat generation, bubble formation, etc.) can also lead to better separation of the bitumen-containing material from the matrix. Furthermore, the matrix itself could be attacked or dissolved by the chemical and/or physical reaction.

In variants, the addition of the second substance can also be dispensed with. Tests have shown that in particular in a process in which the secondary raw material has previously been subjected to an abrasion process, the second substance can be dispensed with, especially from an economic and ecological point of view. It is clear to the skilled person that with the use of a second substance the process can be favored.

Preferably, the second substance comprises sodium hydrogen carbonate and/or acetic acid. Particularly preferably, both sodium hydrogen carbonate and acetic acid are added. This can be used to generate bubbles in the mixture, which carry dissolving bitumen-containing material upwards, to the liquid surface. Furthermore, the individual second substances can serve to detach the bitumen-containing material from the matrix.

In variants, the addition of sodium hydrogen carbonate or acetic acid may also be omitted.

Preferably, the second substance comprises a release agent, in particular a peroxide, preferably hydrogen peroxide, oxygen, hydroxide radicals, perhydroxyl, hyperoxide, bicarbonates, percarbonates, benzene hydroxide, alkali metal hyperoxides (sodium, potassium, lithium) or a combination of the foregoing. With the use of release agents, in particular for example hydrogen peroxide, organic molecules, in particular organic polymers and oils can be broken by means of free radicals, whereby the bond between the bituminous material and the matrix can be loosened. Furthermore, the use of, for example, hydrogen peroxide can attack limestone at the surface, whereby the bituminous material can be more easily detached by this dissolution reaction of the limestone surface. In this case, it is not necessary to dissolve the limestone completely. An analogous effect with other matrix materials can also be achieved with peroxides or other substances. Corresponding reactions are known to the skilled person. The peroxides can be particularly effective in combination with surfactants.

In variants, the above-mentioned substances can also be dispensed with.

Preferably, the second substance comprises surfactants and/or ambiphiles. Especially in combination with peroxides, preferably hydrogen peroxide, a particularly efficient detachment of the bituminous material can thus be achieved. Hydrogen peroxide acts as a catalyst, producing a foam layer in which the bituminous material is emulsified. The oxidative action of the peroxide also breaks down organic pollutants and transfers them into the emulsion.

In variants, the surfactants or the ambiphiles can also be dispensed with.

Preferably, the second substance is produced using an electrochemical and/or chemical system. This allows the second substance to be produced and added in situ. This is particularly advantageous for substances with a higher hazard potential, such as a strong oxidizing agent, as safe working is possible.

In variants, the production of the second substance on site can also be dispensed with.

Preferably, the second substance is added to the mixture in a time-distributed manner so that an overreaction can be prevented. In particular, this prevents sand and filler from being carried to the surface of the liquid together with the bituminous material due to excessive bubble formation.

Preferably, the second substance is added continuously or in several portions during the separation of at least part of the bituminous material from the matrix. In this way, an overreaction can be prevented, whereby the bituminous material can be recovered in greater purity. In the case of continuous addition, conveying means known to the skilled person for liquids or solids can be used (dropping funnel, pump, screw conveyor, etc.). These conveying means can also be used for portion wise addition and preferably meter in fully automatically. On the one hand, the metering quantity can depend on the batch size. Furthermore, the metering can also be controlled, in particular automatically controlled, on the basis of a measured parameter, for example foam formation, heat generation, etc.

In variants, the dosing can also be performed manually. Further, the second substance may also be added in a single dose.

Preferably, during the separation of at least part of the bituminous material from the matrix, a concentration of the second substance relative to a total weight of the mixture is increased to at most 1.0 wt. %, preferably to at most 0.5 wt. %. By the continuous or the discrete addition of the second substance into the mixture, the reaction can be controlled in an optimal range for the separation of the bituminous material. Thus, in particular, the total amount of the second substance in the mixture can also be optimized, which in turn allows the process to be carried out particularly economically. Particularly preferably, this is an oxidizing agent, such as a peroxide, in particular hydrogen peroxide.

Depending on the composition of the mixture or the type of bituminous secondary raw material and the second substance used, higher final concentrations than 1.0 wt. % can also be provided.

Preferably, the second substance is added to the mixture as a solution. This enables particularly simple and precise metering. In variants, the second substance can also be added as a solid.

Preferably, a change in concentration of the second substance relative to the total weight of the mixture is between 10-2 and 10-5 wt. % per minute, preferably between 10-3 and 10-4 wt. % per minute. Preferably, the change in concentration is controlled such that no excessive foaming occurs. This allows the purity of the bituminous material to be increased. It is clear to the skilled person that the change in concentration can also be greater than 0.01 wt. % per minute or even less than 10-5 wt. %. In this case, it is necessary to weigh up the requirements for the quality of the bituminous material against the time required (and thus the cost-effectiveness) of the process.

Preferably, gas bubbles are released in the mixture so that the bituminous material at least partially adheres to gas bubbles and floats to the surface of the mixture. Thus bituminous particles, which could be dissolved from the matrix, can be transported faster to the surface of the liquid. Further, with the rising gas bubbles, the bituminous particles can also be held at the surface of the liquid, provided the density of the liquid is not higher than that of the bituminous material.

In variants, the gas bubbles can also be dispensed with.

Preferably, the gas bubbles are generated by the second substance, in particular by a chemical reaction. Thus, the gas bubbles can be generated directly at the location where the bituminous material is detached from the matrix. Thus, the detachment of the bituminous material can occur simultaneously with the removal via the gas bubbles. This prevents the bituminous material from adhering to the matrix again immediately after detachment. The gas bubbles can be generated, for example, with a separating agent such as a peroxide, whereby, on the one hand, organic compounds can be broken up via the oxygen radicals in order to separate the bituminous material from the matrix and, at the same time, oxygen bubbles can be generated by the oxygen formed, which carry the bituminous material upwards, to the surface of the liquid. In another embodiment, the gas bubbles are formed by the use of sodium bicarbonate, whereby the gas bubbles are formed with carbon dioxide.

In general, the generation of the gas bubbles with the second substance has the advantage that particularly fine gas bubbles can be formed therewith, which can efficiently capture the bituminous material and carry it upwards, to the liquid surface.

In variants, the gas bubbles can also be generated in another way, namely the gas bubbles can also be generated with a pump and/or a separate second container, in particular a pressure container. This may be particularly advantageous if a particularly small amount of the second substance is required to detach the bituminous material, so that too few gas bubbles are generated to transport the bituminous material. On the other hand, second substances may also be provided which do not generate gas bubbles, in which case a pump or a pressure vessel may also be useful for generating the gas bubbles.

Preferably, the gas bubbles are generated by a chemical reaction, the second substance comprising in particular a peroxide, a bicarbonate, a percarbonate or a combination of the foregoing. This choice of second substance enables gas bubbles to be formed particularly efficiently during a decomposition. Preferably, hydrogen peroxide is used due to its low cost and good availability, as well as its reactivity. However, it is clear to the skilled person that other second substances can also be used.

Preferably, the chemical reaction to form the gas bubbles is accelerated by heat and/or by the addition of a catalyst, preferably ferric chloride, ferric oxide, ozone, javel water, potassium iodide or a mixture thereof. Preferably, in the process, this accelerates a decomposition of the peroxide, the carbonate and/or the bicarbonate to speed up the separation process overall. This provides, in addition to time efficiency, a particularly cost-effective process.

By using a catalyst, the decomposition and thus the formation of gas bubbles can be achieved at low temperature. Since a heating process can be dispensed with, the process can thus be carried out more quickly and energy consumption can be reduced. This in turn can minimize the cost of the process.

Heating also accelerates the decomposition reaction of, for example, peroxides such as hydrogen peroxide and carbonates, bicarbonates, etc., respectively. This also allows the process to be carried out in a particularly short time.

In a further variant, in particular in the case of a second substance having a higher reactivity, a catalyst can also be used simultaneously for heating.

In a further variant, the use of catalysts or heating can also be dispensed with. The second substance can also be excited in other ways to form gas bubbles, in particular by a mechanical stress, by microwaves, sound waves, UV light, etc.

In further variants, other peroxides or other separation agents known to the skilled person can also be used to generate gas bubbles. As already explained, the gas bubbles can also be generated otherwise, without chemical reactions, for example by a gas pump or the like.

Preferably, the second substance is metered into the mixture via a first outlet opening below level and wherein a local area around the first outlet opening is heated and/or the catalyst is metered into the local area around the first outlet opening. Local heating means heating a part of the mixture to a temperature which is higher than an average temperature of the mixture. Local heating takes place within the mixture. By metering below level, it is achieved that the gas bubbles are generated within the mixture and thus can achieve the best possible separation effect by their rising in the mixture. Therefore, the first outlet opening is preferably provided near the bottom of the container. In order to achieve gas bubble formation efficiently in the area of the outlet opening, it is intended to accelerate the formation of the gas bubbles there by local heating and/or the addition of a catalyst. In this way, an optimum effect can be achieved in the formation of the gas bubbles with a small amount of energy or catalyst.

In variants, the gas bubbles can also be generated outside the container.

In a particularly preferred process, FeCl₃ is used as the catalyst. This means that a particularly efficient and at the same time ecologically well-tolerated catalyst is used. However, other catalysts are also known to the skilled person, which could be used in the present case.

The catalyst can further be present in particular as a homogeneous catalyst or as a heterogeneous catalyst, such as an iron wire or a suitable ceramic. A heterogeneous catalyst can, for example, be fixedly or detachably connected in the region of the first outlet opening or with the first outlet opening, respectively. Further, a heterogeneous catalyst may also be fixedly or detachably connected to a container wall, in particular a container bottom and/or container walls. In the preferred embodiment, however, the catalyst is present as a homogeneous catalyst. Particularly preferably, the catalyst is metered into the mixture in the form of a solution, in particular an aqueous solution or a suspension.

Preferably, the heating of the local area of the first outlet opening is carried out with steam and/or hot water. The local heating thereby preferably takes place within the mixture. In this way, accelerated decomposition of the peroxide can be achieved without having to heat the mixture as a whole or without having to use a catalyst. Optionally, however, a catalyst can also be used. Likewise, the mixture as a whole can nevertheless be heated to a temperature below the local heating temperature. Thus, the mixture can have a temperature of 30° C. globally, for example, while locally, in the area of the first outlet opening, a temperature of 50° C. or 80° C. prevails, for example. The water vapor and/or the hot water can be used for direct heating by supplying the water vapor and/or the hot water directly to the mixture. In variants, the water vapor and/or the hot water can also be used to heat the local area around the first outlet opening only indirectly, for example by arranging a heating coil (electrical resistance) in this area, for example around the outlet opening or inside the outlet opening.

In variants, the local heating can also be achieved otherwise, in particular for example by another electrical heating, for example with microwaves, ultrasound, infrared and/or electrical resistance for local heating of the water, etc. Other variants are known to the skilled person in this regard.

Preferably, the second substance is metered in via a first tube comprising the first outlet opening. Preferably, the water vapor and/or the hot water or, alternatively or additionally, the catalyst is metered in via a second outlet opening, in particular a second tube. Preferably, the first outlet opening and the second outlet opening are arranged close to each other. In this way, the hydrogen peroxide vapor and/or the hot water or the catalyst can be metered in particularly small quantities directly where it is needed, namely at the first outlet opening. The outlet openings can also be arranged in the container, in particular as openings in the bottom area of the container. Further, an outlet opening can also be in a rotation shaft of an agitator or otherwise connected to an agitator. Further possibilities are known to the skilled person.

In variants, the second outlet opening can also be dispensed with. The catalyst can also be added directly to the mixture, in particular already before the second substance is metered in. A heterogeneous catalyst can also be provided, which is stationary in the region of the first outlet opening. Further variants are known to the skilled person.

In a preferred method, the first tube and the second tube are guided coaxially. Thus a technically particularly simple device is created, with which under level the second substance can be led together with the catalyst, the hot water and/or the steam. In the preferred embodiment, the hot steam and/or the hot water is conducted in the outer tube (in the outer tube means here between the inner tube and the outer tube), while an aqueous solution of the second substance, in particular of a peroxide, is conducted in the inner tube. In variants, however, the hot steam and/or the hot water can also be guided in the inner tube, while the second substance is guided in the outer tube. Especially when hot water and/or hot steam are used, the coaxial pipe guidance is of particular advantage, since the second substance can already be preheated within the pipe. Thus, the bubble formation can be further optimized. In particular, bubble formation can thus already be achieved within the first tube.

In variants, the first tube and the second tube can also be guided separately. This can be particularly advantageous if the second substance is highly reactive. Furthermore, the second tube can also open laterally into the first tube. Thus, for example, the catalyst or the hot water/hot steam can be fed into the first tube of the second substance. The first pipe may further comprise static mixers that optimize mixing of the first substance with the catalyst or the hot water/hot steam, respectively. This may further reduce a catalyst amount.

Preferably, an average temperature of the liquid during the process is below 60° C., preferably below 40° C., more preferably below 30° C., particularly preferably at room temperature. The choice of such an average temperature has the advantage that relatively little heat energy has to be used, which on the one hand avoids a lengthy heating process and on the other hand saves energy. The specific choice of the average temperature can be made depending on the second substance used in order to control a reaction rate. In particular, if a reactive second substance is used to generate gas bubbles, the process can be carried out at a relatively low average temperature. Provided that additional catalysts are used or local heating is performed when the second substance is added as described above, the average temperature can tend to be kept lower. In variants, the temperature can also be selected higher than 60° C.

In a preferred embodiment of the process, a catalyst in aqueous solution is introduced into the second vessel. Via a first feed line, a gas bubble-generating substance, preferably a peroxide, particularly preferably hydrogen peroxide, a carbonate, a percarbonate or a combination of the foregoing is metered into the second vessel. A gas formed in the second vessel is fed below level into the first vessel via a connecting line. In this variant, a particularly small amount of a catalyst can be used to generate the gas bubbles. Iron III chloride is preferably used as the catalyst, but iron oxide, ozone, javel water, potassium iodide or a mixture thereof can also be used as an alternative. In principle, the catalyst can also be dispensed with. In this case, the second container can be heated, for example, to accelerate decomposition of the gas bubble-generating substance. Other methods are also known to the skilled person.

The gas bubbles can also be achieved by a mixing process or a stirring process. In such a mixing process, grinding effects can be achieved at the same time, whereby a separation of the bituminous material can be favored.

In a particularly preferred embodiment of the process, the bituminous material, which is still contaminated with sand, grit and filler, is mixed with water after the abrasion process. This allows the sand, grit and filler to be separated from the bituminous material. In variants, other processes can also be used. The mixing process is preferably carried out in such a way that air bubbles are introduced into the suspension. This can be achieved analogously to a household mixer by stirring so vigorously that a deep drum is formed, whereby air can be introduced into the suspension. With the rising air bubbles, the bituminous material can be carried to the surface and discharged, for example, via a slurry aspirator. In variants, the bituminous material can also be separated by other means. The air bubbles or gas bubbles may also be chemically generated or generated via a pump or the like.

Finally, the generation of gas bubbles can also be generally dispensed with. In this case, the transport of the bituminous material to the liquid surface can also be ensured by convection, a flow pattern, by density differences between the bituminous material and the liquid, etc.

Further, the bituminous material could also be carried upward by apolar droplets of a first substance having a lower density than that of the polar liquid. The apolar droplets can be generated, for example, with an alkane, a water-insoluble alcohol, etc. The droplets can be introduced, for example, in the form of an emulsion in the bottom region of the container. Finally, other possibilities are known to the skilled person.

Finally, gas bubbles as well as apolar liquid droplets can be dispensed with. The bituminous material, provided its density is greater than that of the liquid, can also be discharged in the bottom region of the container. Further, the bituminous material can be filtered, sieved, decanted, etc. from the liquid. Many other techniques are known to the skilled person for this purpose.

Preferably, the gas bubbles comprise ambient air, oxygen, nitrogen and/or carbon dioxide. In particular, oxygen and carbon dioxide can be produced particularly easily by chemical means. All gases are also inexpensive to produce. Ambient air is particularly preferred when a pump is used, since it is freely available.

However, other gases for generating the gas bubbles are also known to the skilled person. In particular, noble gases, hydrogen, etc. can also be used. Gaseous or vaporized organic substances can also be used in principle. In this way, the density of the bituminous material can be reduced at the same time, which can promote floating on the liquid.

In a further preferred variant, the mixture is heated, in particular directly and/or indirectly, preferably with hot water, hot water and/or steam. Heating can accelerate the detachment of the bituminous material from the matrix. Furthermore, any chemical reactions, in particular caused by the second substance, can also be favored. This accelerates the overall separation process. Due to the time savings, production can thus be carried out more economically. In a first variant, the vessel can be heated directly. Heating can be carried out directly, by preheating the liquid, by introducing hot steam into the mixture, or via a vessel outer wall. Other variants are known to the skilled person.

In variants, heating of the mixture can also be omitted. In particular, in a process in which the secondary raw material was previously subjected to an abrasion process, tests have shown that heating can be dispensed with, especially from an economic and ecological point of view—the skilled person is aware that heating can nevertheless typically benefit the process. In particular, it has been recognized that the process can be carried out with the secondary raw material obtained from an abrasion process from road pavement material, namely the abrasion, in a particularly ecological and economical way, by adding only water to the abrasion and mixing it at room temperature in such a way that air is introduced into the suspension, which rises to the liquid surface as air bubbles together with the bituminous material. There, the bituminous material can be sucked off, for example in the form of a foam, with a slurry aspirator. However, it is clear to the person skilled in the art that the process could also be made more efficient by chemical additives, by heating, etc.

In further variants, other means, for example, microwave energy, electrical energy, fuels, in particular, for example, parts of the bituminous material, etc., can also be used. In the case of burning parts of the bituminous material, in particular for example a fraction of the bituminous material, the excess heat can be used to produce electrical energy which can be used for the process or otherwise.

In another preferred embodiment, the mixture is heated to a temperature above 50° C. By increasing the temperature of the entire mixture, more energy is expended, but the process can be carried out in a shorter time. Experiments have shown that above 50° C. the process works well. Temperatures above 80° C., especially above 90° C., for example up to 100° C., are ideal. Depending on the type of secondary raw material and depending on the addition of additives such as the peroxides, carbonates, bicarbonates, etc. described above, the process can also be carried out at temperatures below 50° C. or the mixture can be heated only locally. Depending on the second substance used, especially when hydrogen peroxide is used, an overreaction can be prevented by a lower temperature, if necessary. Here, a trade-off can be made between the temperature of the mixture and the addition rate (change in concentration) of the second substance, typically lowering the addition rate at a higher temperature.

Preferably, the mixture is mechanically mixed, particularly to maximize yield. With the mixing, the bituminous material can also be mechanically dissolved on the one hand.

Furthermore, a chemical reaction caused by the second substance can be implemented more quickly. Overall, this also speeds up the process itself. Preferably, this also increases the yield of the bituminous material.

In variants, mechanical mixing can also be dispensed with.

Preferably, the mixture is acted upon by physical means, in particular by sound, ultrasound and/or microwaves. This can also optimize the detachment process of the bituminous material from the matrix. For this purpose, it is advantageous if the frequency is set in such a way that bituminous droplets or particles are optimally excited. The frequency is therefore preferably less than 200 kHz, particularly preferably less than 100 kHz, especially less than 50 kHz. If necessary, it may also be useful to excite microscopic particles, for example those to which the bituminous material adheres. In this case, frequencies above 200 kHz may also be provided.

In variants, the physical means can also be dispensed with.

The process is preferably carried out discontinuously. For this purpose, a quantity of the secondary raw material, in particular road surfacing material, is placed in a container and covered with the liquid, in particular water. The bituminous material accumulating on the water surface is skimmed off, preferably continuously. In variants, the process can also be carried out continuously. For this purpose, the secondary raw material can be conveyed by conveying means, for example via a conveyor belt, into a container and continuously discharged again from the container via a screw conveyor. Techniques for optimizing the residence time of the secondary raw material in the container are known to the skilled person.

Preferably, the process is carried out as ecologically and economically as possible. In this way, the environment is less polluted and the process can be carried out relatively inexpensively.

Preferably, after the bituminous material has been separated, the liquid, in particular the water, is treated for reuse in the process, in particular for a next batch. The treatment of the liquid can be designed in such a way that the requirements for reuse in the process are met. For example, to the extent that common salt is dissolved in the water to increase density, this does not need to be removed from the water as part of the treatment. Typically, it may be sufficient to run the water through a settling tank or centrifuge it with a cyclone to remove suspended solids. In variants, treatment may not be necessary at all, especially if the impurities do not negatively affect the process. In this case, the liquid can be directly reused in the process or disposed of.

Preferably, one or more heat exchangers are used to recover process heat. This is preferably recovered from the liquid, in particular the water. Corresponding techniques are sufficiently known to the skilled person. The recovered heat can be used directly to preheat the liquid for the process or otherwise (for space heating, hot water boiler, etc.).

In variants, heat recovery can also be omitted.

The bituminous material is preferably skimmed off at the liquid surface, in particular in the form of a foam, continuously or discontinuously. In particular, in a variant in which gas bubbles are generated, a foam is typically generated at the liquid surface in which the particles of the bituminous material are located. This foam can be skimmed off the liquid surface by a sword. Further, the foam can also be driven towards an overflow by a suitable agitator. Other variants are also known to the skilled person in this regard.

In variants, the bituminous material can also be discharged from the mixture via a sludge suction device or also otherwise. The use of a mud suction device has the advantage that it is positioned between 1 and 100 mm above the water surface, whereby agitated sand or filler is discharged to a lesser extent. Bituminous material with higher purity is thus obtained.

Preferably, the bituminous material is subjected to a further cleaning step after separation from the matrix. After the separation process, the bituminous material may comprise impurities, in particular sand, fillers and additives. The separation can be carried out using techniques known to those skilled in the art.

Depending on its use, the bituminous material can also be used directly after the separation process for the production of asphalt pavements, possibly specific ones, in which the impurities in the bituminous material do not interfere or are even desired.

Preferably, the bituminous material is slurried in a liquid, in particular in water, and mixed or blended to separate fillers, sand and other substances from the bitumen. For this purpose, the bituminous material can be subjected to a grinding process beforehand—whether the grinding process is used can depend on the desired purity or the grain size of the bituminous material, etc. The grinding process can also be dispensed with. The grinding process can also be omitted. It is particularly preferred to use a liquid which has a higher density than the bitumen on the one hand and a lower density than the fillers or sand and grit on the other. Thus, an optimal separation within the liquid can be achieved in such a way that the bitumen rises to the surface of the liquid and the fillers, the sand, the grit and possibly other materials with higher density collect at the bottom of the container. The liquid preferably comprises water in which a density-increasing first substance is dissolved. It is also possible to dispense with influencing the density. Separation can also be achieved by a suitable choice of flow, whereby parts of lower density (bitumen) can be separated from parts of greater density (filler, sand, etc.). For this purpose, for example, flow generated by an agitator, in particular buoyancy, can be provided. Preferably, this further cleaning step is carried out without chemical additives. Experiments have shown that, in particular in the case of bituminous material obtained from road pavement material according to the process, the second substance (separating agent) can generally be dispensed with in this further cleaning step. This means that this further cleaning step can be carried out particularly economically and ecologically. Even if bituminous road pavement concentrate is used, which has been mechanically concentrated (by the abrasion process), a release agent, i.e. the second substance, can be dispensed with if necessary. Intensive mixing can further introduce air bubbles into the suspension, which in turn can improve the release effect. Thus, air bubbles are absorbed, which in turn create a bituminous slurry or foam that contains less sand and filler.

In variants, after separation from the matrix, the bituminous material can be separated from foreign matter, especially filler and sand, by centrifugation or via a centrifugal separator (cyclone). This allows the bituminous material to be used again universally for the production of asphalt pavements. Separation does not necessarily have to be by centrifugation; other techniques are also known to the skilled person.

In variants, the separation of the foreign bodies can also be dispensed with.

Preferably, the secondary raw material passes through the process several times to achieve a higher separation efficiency. On the one hand, this enables a higher yield of bituminous material to be achieved. On the other hand, the sand and grit can be better cleaned, which means that they can also be reused. Furthermore, the separated bituminous material can also be run through the process repeatedly, whereby filler and sand can be further removed from the bituminous material in order to achieve a greater purity of the bituminous material.

In variants, the second pass can be omitted, especially if the first pass was sufficiently efficient.

Preferably, the process is carried out under negative pressure. In particular, this favors or accelerates a process in which the bituminous material is carried to the surface of the liquid with gas bubbles.

In variants, carrying out the process at negative pressure can also be dispensed with.

Preferably, the secondary raw material comprises grit, sand and filler. These constituents occur in particular in road surfacing material, but can in principle also occur in other secondary raw materials.

Particularly in the production of road surfacing material, the aim is to select the components and process them in such a way that the bituminous material adheres to the matrix in the best possible way. Fillers and adhesion promoters are usually used for this purpose. In principle, these additives make it difficult to detach bituminous material from the matrix—but the present process has surprisingly shown that, despite these aggravating circumstances, road surfacing material can also be separated into bituminous material and matrix.

In variations, the secondary raw material may also comprise no grit, no sand, and/or no filler.

Preferably, the secondary raw material comprises a water content of less than 5% by weight, more preferably less than 1% by weight, particularly preferably less than 0.1% by weight. Again, the low water content is in principle disadvantageous for the separation of the bituminous material from the matrix. A higher water content typically favors the separation of the bituminous material, especially since the bituminous material is apolar and the water is polar. However, it has been surprisingly shown that the process is nevertheless suitable for separating the bituminous material even from secondary raw materials with particularly low water content.

In variants, the water content of the secondary raw material can also be higher than 5 wt. %.

In a preferred embodiment of the process, the secondary raw material is preferably present as fragments, at least a proportion of 10% by weight, preferably at least 20% by weight, of the fragments having a minimum diameter of more than 10 mm.

Again, in principle, a larger fragment size is typically disadvantageous for the separation process. However, it has now been surprisingly shown in trials that the secondary raw material does not have to be crushed to an arbitrarily small size in order to be able to carry out the process efficiently.

Particularly in the case of demolition material used in road construction, the fragments immediately after road demolition can be very large. For the execution of the process, these have to be crushed. However, the size of the fragments does not have to be arbitrarily small, but can be up to 80 mm or more. This means that the process can be carried out at low cost. Furthermore, this can prevent destruction of the grit and sand, which means that these materials can also be reused after separation.

In variants, however, the fragments can also be smaller or of the size indicated above with a smaller proportion of the total mass. The fragments may also be crushed, ground or otherwise reduced to smaller particles.

Preferably, at least 20% by weight, preferably at least 30% by weight, more preferably at least 40% by weight of the matrix has a particle size greater than 5 mm. Here, too, the above applies, according to which large particle sizes are in principle disadvantageous for the process, but the present process has proved surprisingly efficient even with large particle sizes.

In variants, less than 20 wt. % of the matrix can also have a grain size of more than 5 mm.

Preferably, the secondary raw material comprises one or more of the following: Polymers, reinforcing fibers, in particular cellulose fibers and/or aramid fibers, hydrated lime, juvenators. Such additives or components are typically used in asphalt pavements. Polymers and hydrated lime in particular are typically found in asphalt pavements. These additives ensure that the bituminous material adheres particularly well to the matrix material, especially grit and crushed sand. The present process proved to be efficient even under these circumstances, which make separation difficult.

None of the components is necessary for carrying out the process. However, it was shown that the process works even when some or all of these components are present in the secondary raw material.

Preferably, the amount of hydrated lime in the secondary raw material is between 0.5 and 3 wt %, preferably between 1 and 2 wt %. In variants, the proportion of hydrated lime can also be higher than 3 wt. % or lower than 0.5 wt. %.

The proportion of polymers in the bituminous material is preferably at least 2 wt. %, more preferably at least 4 wt. %, in particular between 5 and 7 wt. %. In variants, the proportion of polymers can also be below 2 wt. % or above 7 wt. %.

Preferably, the secondary raw material has a density between 1.2 g/cm3 and 2.6 g/cm3, preferably between 1.4 g/cm3 and 2.4 g/cm3. In variants, the density can also be less than 1.2 g/cm3 or greater than 2.6 g/cm3.

Preferably, a proportion of VOC or VVOC in the secondary raw material is less than 0.1 wt. %, preferably less than 0.01 wt. %. VOC and VVOC are volatile organic compounds. VVOCs include organic compounds with a boiling range with an upper limit of 100° C. VOCs are organic compounds with a boiling range between 100° C. and 260° C. The VOCs or VVOCs are useful for separating bituminous material from the matrix, since they are also apolar and thus serve as solubilizers for the bituminous material. The VOCs or VVOCs dissolve a surface of the bituminous particles, which can reduce a holding force to the matrix. However, it has now been discovered that the present process can also be used to separate bituminous material from a matrix that contains little or no VOCs or VVOCs.

In the production of asphalt, the bituminous material in the road surfacing material is typically applied to sand, grit, etc. at a temperature of 120° C. to 230° C., which has been preheated to 400° C. (other parameters are also possible). This means that a large proportion of the VOCs or VVOCs are already volatilized during the production of the asphalt. Residual amounts of volatile organic compounds diffuse out of the pavement over time, so that it typically contains practically no volatile organic compounds when rehabilitation is imminent. It should now be noted in particular that due to the extensive absence of lighter oils, i.e. VOCs or VVOCs, in the (old) pavement material, a solubilizer is missing which would help to dissolve the bituminous material from the matrix. Surprisingly, with the present process, the bituminous material can now be efficiently dissolved from the matrix even in the absence of VOCs or VVOCs.

In variants, the process can of course also be applied to secondary raw materials that have a higher VOC or VVOC content than 0.1 wt. %.

Preferably, the bituminous material in the road surfacing material has less than 0.1 wt. %, preferably less than 0.01 wt. % of distillable petroleum components or hydrocarbons. Surprisingly, it has been shown that the process also works well when the distillable petroleum components or hydrocarbons are very low—this means that the process can also be carried out efficiently to a large extent without solubilizers.

In variants, the proportion of distillable petroleum components or hydrocarbons can also be higher than 0.1 wt. %.

Preferably, a kinematic viscosity at 60° C. of the bituminous material is higher than 400 mm2/s, preferably higher than 1,000 mm2/s. Particularly preferably, the kinematic viscosity of the bituminous material in the secondary raw material is higher than 5,000 mm2/s, more preferably higher than 10,000 mm2/s. In the application of the present method, the kinematic viscosity may even be higher than 25,000 mm2/s. Such values for the kinematic viscosity are typically achieved in bituminous material in old road surfacing material. Here, too, a high kinematic viscosity of the bituminous material in principle stands in the way of efficient separation of the matrix—surprisingly, the present process can also be used to separate bituminous material with very high kinematic viscosity from the matrix.

Again, it is clear to the skilled person that the process can also be carried out at kinematic viscosities lower than 400 mm2/s.

Preferably, a density of the bituminous material is greater than 1,000 kg/m3, preferably greater than 1,010 kg/m3. Together with the viscosity and the low content of volatile organic compounds, the density typically also increases for the bituminous material. Experiments have shown that even at a density of the bituminous material higher than that of water, separation from the matrix is possible and, in particular, economically feasible. It has even been shown that separation can be achieved at the water surface, in particular, for example, in a process in which gas bubbles are generated in the mixture. However, the process can also be carried out with a secondary raw material in which the bituminous material has a lower density than water, i.e. than 1,000 kg/m3.

Preferably, the bituminous material has a softening point of more than 50° C., in particular more than 70° C., more preferably more than 90° C. The softening point of the bituminous material in a road pavement typically increases with age. In variants, the softening point can also be lower than 50° C.

The bituminous material obtained by means of the process, which has been separated from a secondary raw material, is preferably used for the production of asphalt. If the secondary raw material comprises already asphalted road surfacing material, the advantage is that any impurities do not have to be removed from the bituminous material, since such impurities would be returned to the asphalt anyway. This creates a particularly economical reuse of bituminous material from road surfacing material. However, other applications of the recycled bituminous material are known to the skilled person. If necessary, the bituminous material can also be processed or cleaned for this purpose.

A device for carrying out the process essentially comprises a container into which the liquid and the secondary raw material can be placed. In a preferred embodiment, the container can have a taper towards the container opening. This has the advantage that the floating bituminous material rests on a smaller area and can thus be skimmed off in higher concentration. A further advantage is that the secondary raw material can be covered with a smaller quantity of liquid. This means that the process as a whole can be carried out with a smaller volume. Another advantage is that there is less movement of the liquid surface during agitation, which can also prevent the separated bituminous material from coming into contact with and reattaching to the secondary raw material below the liquid surface. In variations, the container can also be without the taper.

In another preferred embodiment, the apparatus for carrying out the process comprises a sword washer or Archimedean screw, whereby the bituminous secondary raw material can be transported through the liquid and discharged.

Preferably, the separation process is monitored with sensors. Monitoring can be performed online, continuously or discontinuously.

Continuous monitoring can be performed, for example, by using sensors that are in contact with the mixture during the process. Discontinuous monitoring can be carried out, for example, by regularly taking samples, which are analyzed in each case. Many suitable sensors are known to the skilled person, which can be used for monitoring the process. On the one hand, they can be used to monitor primary factors, such as the effective separation of the bitumen from the matrix, which can be used, for example, to determine when the separation process is complete (whether the pebble/sand is clean). This allows the optimization of the residence time of the materials in the reactor as well as the optimization of the amount of substances to be added, such as bicarbonates, peroxides, etc.

On the other hand, or in addition, secondary factors such as temperature, density, pH, conductivity, refractive index, etc., as well as rates of change thereof and the like, can also be monitored. In a preferred embodiment of the method, an addition of a first and/or second substance is carried out on the basis of the values measured with the sensor. In this way, the process can be carried out particularly efficiently and with optimized use of resources (energy, time, additives, etc.).

In variants, monitoring with sensors can also be dispensed with. In this case, monitoring of the process can also be performed visually.

Preferably, the sensor comprises an optical sensor, in particular a UV-vis fluorescence sensor, X-ray fluorescence sensor, Raman spectroscopy sensor, image recognition photography, NIR, etc. In variants, other sensors known to the skilled person can also be used. In particular, a combustion test with detection of combustion gases can also be performed during sampling (for example, by optical spectroscopy (NIR or other), etc.

Other advantageous embodiments and combinations of features come out from the detailed description below and the entirety of the claims.

### BRIEF DESCRIPTION OF THE SEVERAL VIEWS OF THE DRAWINGS

Further advantages, features, and details of the various embodiments of this disclosure will become apparent from the ensuring description of a preferred exemplary embodiment and with the aid of the drawings. The features and combinations of features recited below in the description, as well as the features and feature combination shown after that in the drawing description or in the drawings alone, may be used not only in the particular combination received, but also in other combinations on their own, without departing from the scope of the disclosure.

The drawings used to explain the embodiments of the presently disclosed invention depict the following:

FIG. 1 depicts a schematic representation of a vertical section through an asphalt layer;

FIG. 2 depicts a schematic representation of a vertical section through crushed asphalt in the form of a conglomerate;

FIG. 3 depicts a schematic representation of a vertical section through milled asphalt;

FIG. 4 depicts a schematic representation of a vertical section through a container with a mixture;

FIG. 5 depicts a schematic representation of a vertical section through a container during the separation process or disaggregation;

FIG. 6 depicts a schematic representation of a vertical section through a container during the separation process in greater detail;

FIG. 7 depicts a schematic representation of a vertical section through a device for continuous execution of the process;

FIG. 8 depicts a schematic representation of a first embodiment of a device for carrying out the process with a device for generating gas bubbles;

FIG. 9 depicts a schematic representation of a second embodiment of an apparatus for carrying out the process with a separate reactor for generating gas bubbles;

FIG. 10 depicts a schematic representation of a third embodiment of a device for carrying out the process, in which the bitumen is skimmed off at the liquid surface; and

FIG. 11 depicts a schematic representation of a fourth embodiment of a device for carrying out the process, wherein the bitumen is collected at the bottom of the container and discharged.

In the figures, the same components are given the same reference symbols.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that at least one of “A, B, and C” should not be understood as including only one of A, only one of B, only one of C, or any combination of A, B, and C.

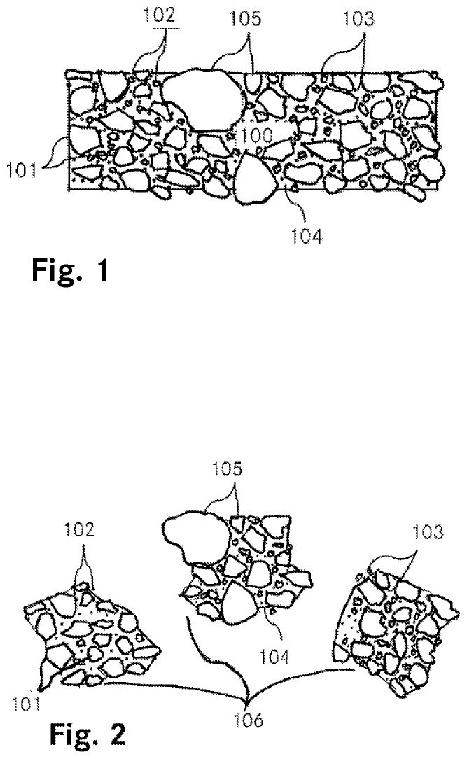

FIG. 1 shows a vertical section through an asphalt layer 100 in the form of a conglomerate. This comprises conglomerates 101, which include more or less large pebbles, sands 102, fillers 103 and bituminous material 104. The road surface is 105. As the road wears, the conglomerates 101 become rounded, making the road slippery and requiring rehabilitation. The road surface is either milled off or broken out.

FIG. 2 shows a vertical section through a broken asphalt layer. The broken pieces 106 are relatively large and still include a large number of sand particles and several pebbles 102.

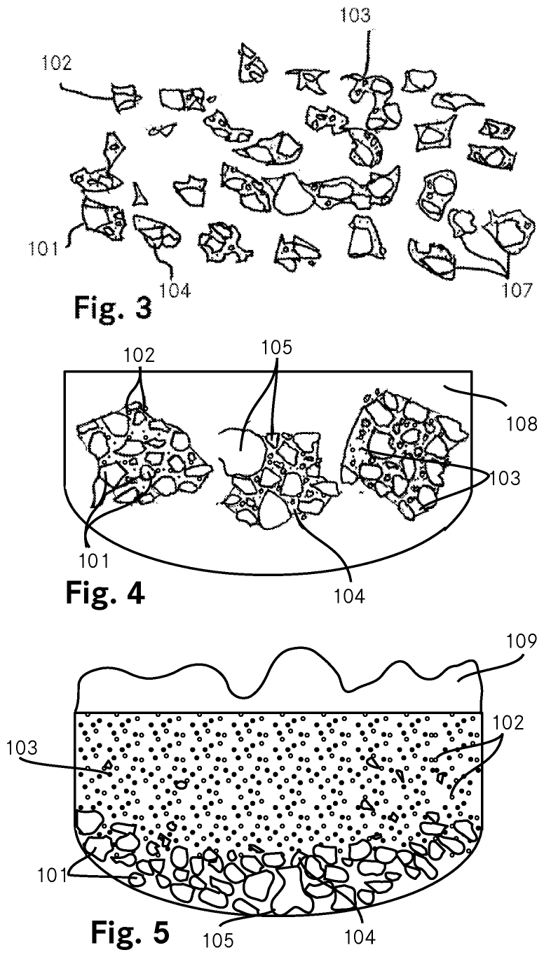

FIG. 3 shows a vertical section through a milled asphalt layer. The particles of milled material 107 are much smaller than those of the crushed asphalt pieces of FIG. 2. A particle 107 now still comprises one or a few pebbles. The dust content is increased by the milling process, which typically enriches the bituminous material with the dust in the separation process.

FIG. 4 shows a vertical section through a container containing a mixture. The mixture includes an aqueous solution 108 and fragments 106 of the pavement material shown in FIG. 2.

FIG. 5 shows a vertical section through a container during the disaggregation/separation process. The fragments 106 are already disaggregated into bituminous material and the matrix. The pebbles 101 and sand 102 collect at the bottom, while the bituminous material dissolved from the matrix collects in the foam 109.

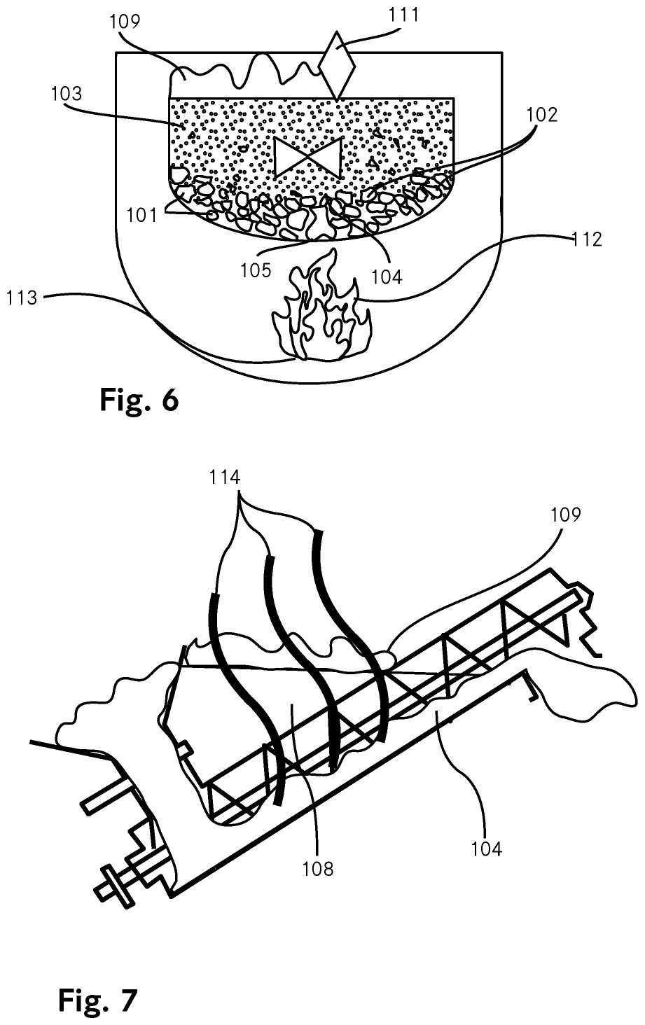

FIG. 6 shows a vertical section through a container during the disaggregation/separation process in greater detail. The pebbles 101 and sand 102 collect at the bottom of the container during the process. In the present case, a mixer 110 is provided in the container, with which the mixture can be circulated. This can increase the efficiency of the process. A skimming system 111, for example a sludge suction device, is used to continuously skim off the foam that forms and thus the bituminous material separated from the matrix. Further, a heat source 112 is arranged below the vessel, with which the mixture can be heated during the process. A pipe 114 can be used to supply a reactive substance, in particular a separating agent such as a peroxide, in such a way that it reaches the asphalt directly. The peroxide can thus be brought close to the asphalt continuously or by successive additions, whereby it can be effectively used to separate the bituminous material from the matrix.

FIG. 7 shows a vertical section through an apparatus for continuously performing the process. The apparatus includes an entry for the bituminous secondary raw material 104, which is conveyed obliquely upward along a vessel via an Archimedean screw, through the aqueous solution 108, and finally discharged from the vessel via an overflow. A sword scrubber can also be used instead of the Archimedean screw.

The experiments performed on the separation process are described below. In each of the following experiments, milled material from a road pavement was used as secondary raw material.

In the first experiment, 5 g of milled material from a road surface was crushed and mixed with 10 ml of 3% hydrogen peroxide in a container. The container was placed in a pressure cooker containing water and boiled for 5 minutes. A foam with 1 g dry mass, including bitumen and filler, was found on the hydrogen peroxide solution in the container.

In a second experiment using a water bath heater, 300 g of milled material from a road pavement was crushed and placed in a beaker. The milled material was mixed with 500 ml of a 3% hydrogen peroxide solution. The beaker was heated to 60 to 65° C. in a water bath. Bubbles formed, which carried the bitumen to the surface, where a foam was formed. When increased to a temperature of 80° C., the process was more efficient, and at 95° C. the separation proceeded for 10 minutes under very good conditions, achieving good separation of the bituminous material from the matrix.

In a third test, 6.8 kg of milled material from a road pavement was crushed and placed in a container. The milled material was covered with water. The mixture was then heated to 60° C. and 100 ml of 35% hydrogen peroxide solution was added. The mixture was stirred and the foam was skimmed off at regular intervals. After four hours of skimming and addition of hydrogen peroxide (every 30 minutes), the process was stopped. The matrix was almost completely freed from bituminous material. The matrix weighed 4.1 kg and the bituminous material weighed 1.6 kg. Fine residues in the water made up the remainder of the milled material. Since the road pavement contains only about 6% bituminous material, only about 400 g of bituminous material is in the 1.6 kg, the rest is likely to be filler, dust, fragments, etc. The large amount of fine material can be attributed to the crushing of the milled material.

In a fourth test, a block of 3.8 kg of milled material from a road pavement was used. This was broken into pieces of 40 to 80 mm diameter. The broken pieces were covered with water in a container and heated up to a temperature of 60° C. The water was used to heat up the material. During 2.5 hours, 160 ml of 35% hydrogen peroxide solution was continuously added. The conglomerates were disaggregated in a few minutes. The foam was skimmed off regularly. The mixture was boiled up. The remaining matrix was bitumen-free and weighed 2.9 kg. The bituminous material weighed 0.7 kg, with the filler accounting for 165 g. The theoretical amount of bituminous material was 230 g, with filler and dust accounting for 228 g-about 6% of the original amount of milled material.

These experiments have shown that the crushing process can have the disadvantage that dust accumulates in the bituminous material. Thus, by using fragments of road pavement directly, bituminous material with greater purity can be obtained.

In a fifth experiment, on the one hand the density of water was increased in order to increase the buoyancy of the bituminous material in water. Bituminous material in road pavements typically has a higher density than water, namely between 1.01 and 1.05 kg/L. Thus, there is a risk that the bituminous material will collect at the bottom of the tank after it is released from the matrix. This effect can be counteracted by adding a density-increasing salt or a density-increasing liquid. The salts may be sodium chloride, magnesium chloride, potassium chloride, sodium carbonate or sodium nitrate. For example, glycerol or the like may be used as the liquid. The separation can also be carried out in pure glycerol.

In a sixth experiment, 5 kg of milled material from a road surface was used and mixed with 7.5 L of water without table salt. The mixture was heated to 95° C. and stirred with a paddle mixer. Subsequently, 100 g of sodium bicarbonate in powder form was added every 15 minutes. After 6 additions and 2 hours of reaction time, 1.3 kg of bituminous material was obtained at the water surface. Most of the 3.7 kg matrix was separated from the bituminous material. The water contained suspended solids.

These experiments show that the process can be carried out with different substances (bicarbonates, acetic acid, peroxides, percarbonates, etc.).

In a seventh experiment, 5 kg of milled material was mixed with 5 liters of water and rubbed with a powerful mixer for two hours (abrasion method). After two hours, the grit (gravel) were tested. The grit contained some bitumen in the concave areas. The abrasion contains the large part of bitumen.

Now, about 10 wt. % CaCl₂) was dissolved in 600 ml of the above residual water containing filler and sand with bituminous material, and 1 ml of 35 wt. % H₂O₂ was added and heated. A bituminous residue was extracted and the sand and filler were decanted. After 24 hours, this part represented 180 ml and no longer contained bitumen. 200 g of grit, which contained a little bitumen, was again treated in 600 ml of water with 1 ml of H₂O₂ and heated. After the treatment, the grit was cleaned of bitumen.

In another experiment, 400 ml of the above residual water, which contained filler and sand with bituminous material, was mixed with 300 ml of water and blended in a blender (which are also used to blend smoothies). Mixing creates many air bubbles in the suspension, which carry the bituminous material to the surface in the form of a foam. Sand and filler, on the other hand, sediment due to their higher density. The process works without chemical additives and also without additives to increase the density of the water.

These variations show that it is possible to combine different techniques (abrasion, fractionation, etc.) to obtain the best efficiency (efficiency, purity, etc.).

In an eighth experiment, approximately 80 kg of milled material was heated and mixed in 200 L of water at 90° C. During the process, 10 ml/min of H₂O₂ was injected through a pump. To increase the density of the water, 25 kg of sodium carbonate was added. After two hours of reaction, 10 kg of bituminous residue and 70 kg of mineral were collected. This demonstrated that purification could be carried out without chloride salt.

In a ninth experiment, 10 kg of milled material was placed in 20 L of water and heated with sodium bicarbonate. The bituminous material rose to the surface but fell back down because the density difference was not sufficient to keep the bituminous material on the water surface. To recover the residue on the water surface, a stream of carbon dioxide (CO₂) was introduced at the bottom of the vessel, causing the bituminous material to convect to the surface where it could be collected. This experiment shows that it is possible to collect the bituminous residue on the liquid surface without increasing the density of the water with salt or sugar.

In a tenth experiment, the dried bituminous material was post-processed to extract the bitumen from the filler and sand. In fact, the bituminous residue may contain 25% to 33% bitumen by weight, while the remainder comprises small mineral particles. The bituminous material was placed in a container with water and post-processed by vigorous mixing with a mixer. This separated the bitumen from the filler and sand. By adding salt to the water, the bitumen floated on the surface while the mineral part sedimented. This allowed the bitumen to be concentrated.

In the case of road pavements, the bituminous material intentionally adheres particularly strongly to the fillers, to the sand and grit. A layer thickness can reach several hundred micrometers. As a result, the bituminous material is removed layer by layer from the matrix during the process. This in turn means that rapid addition of a reactive substance, in particular a release agent, for example a peroxide, can have the following disadvantages:
an excessively violent reaction is triggered, producing a large amount of foam. With the gas bubbles, not only the bituminous material, but also a lot of sand and filler is carried upwards, into the foam;
the peroxide can also react with already separated bituminous material, oxidizing the bituminous material. Thus, the peroxide is used inefficiently.

These problems can be addressed by two measures. On the one hand, the peroxide can be added in doses so that a low concentration is always present. Furthermore, it is advantageous if the peroxide is added in the area of the secondary raw material, i.e. in the area of the bottom of the container. This can be done, for example, via a dip tube.

In this fifth experiment, 280 kg of milled material from a road pavement was used and mixed with 250 L of water and 25 kg of common salt. The mixture was heated to 60° C. and stirred with a paddle mixer. Subsequently, 100 ml of 35% hydrogen peroxide solution was added via a dip tube after every 10 minutes. Alternatively, the addition can also be carried out continuously via a pump. After 14 additions of 100 ml hydrogen peroxide solution a 35% and 2 hours reaction time as well as 1 hour material collection, 45 kg bituminous material was obtained at the water surface. Most of the matrix was separated from the bituminous material. The salt water contained suspended solids.

The mode of operation is not fully understood. It is possible that the introduction of the peroxide solution results in a relatively acidic pH, which dissolves lime residues and releases bicarbonate. The bicarbonate, in turn, acts together with peroxide as a powerful cleaning agent, which in turn can effectively separate the bituminous material from the matrix.

In another preferred process, the use of catalysts accelerates the formation of gas bubbles, whereby the temperature of the mixture in the vessel can be kept lower. This can save heating time on the one hand and heating energy on the other. This results in a particularly efficient and cost-effective separation process.

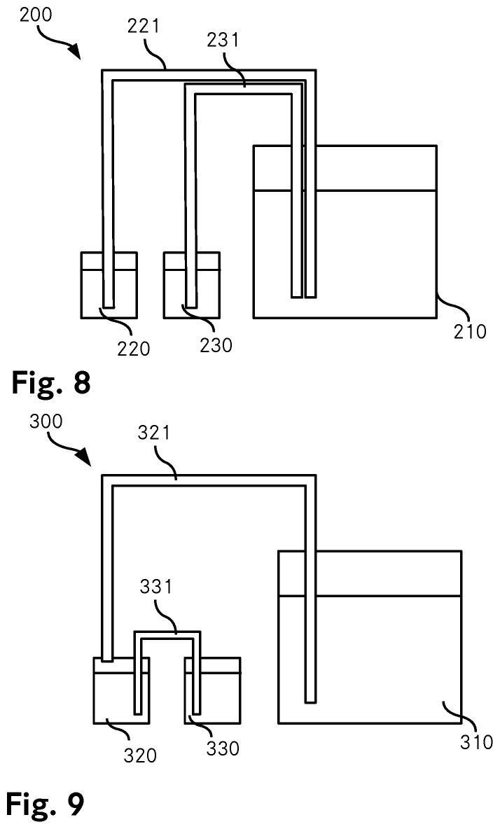

FIG. 8 shows a schematic representation of a first embodiment of an apparatus 200 for carrying out the method with a device for generating gas bubbles. The apparatus 200 comprises a container 210 in which the milled material is mixed with water. Further, the apparatus 200 comprises a first dosing container 220, in which hydrogen peroxide (alternatively, other substances, in particular other peroxides, carbonates or bicarbonates, etc., may be provided) is provided in aqueous solution. The solution is metered into the container 210 via a line 221. In a second metering container 230, a catalyst, presently iron-Ill-chloride, is provided in aqueous solution. This catalyst solution is metered into the container 210 via a separate line 231. The solutions are metered in each case by a pump not shown. The lines 221 and 231 open side by side below level in the container 210, so that a decomposition reaction takes place immediately after the catalyst solution and the hydrogen peroxide solution are discharged, whereby gas bubbles are generated which bring the bitumen to the surface. The two lines 221 and 231 may terminate in a static mixer or the like for better mixing. A paddle mixer (not shown) is further provided in the container 210 to circulate the milled material during the process.

In another embodiment, the catalyst is mixed with the water directly in the vessel, which also eliminates the need for the conduit 231.

The materials (milled material, catalyst, etc.), which are suspended or dissolved in the water, can be introduced using various technical devices, for example, scraper, vibrator, inclined plane, mixer, inclined rotating drum, conveyor belt, screw conveyor, etc.

In another embodiment of the process, instead of the catalyst solution, superheated steam is fed via line 231 into the local area of the outlet opening of line 221. This allows a gas bubble generating substance, for example the peroxide, to be heated locally to accelerate decomposition.

In another embodiment, a catalyst solution is heated, thereby accelerating the decomposition reaction simultaneously by heat and the catalyst. This embodiment may be used for typically more reactive substances.

While in the first embodiment the two conduits 221 and 231 are parallel, in a further embodiment they may be coaxial, as an inner tube and an outer tube. Further, the pipelines, whether routed in parallel or coaxially, may also be connected from an outer side of the container 210 to openings in the bottom of the container. This can be advantageous, since it means that an agitation process in the container 210 is not hindered by pipes. Further, the lines may also terminate in a common end pipe.

FIG. 9 shows a schematic representation of a second embodiment of an apparatus for carrying out the process with a separate reactor for generating gas bubbles. The apparatus again comprises a container 310 in which the bituminous material, in this case bituminous milled material, is mixed with water. In a first dosing container 320, hydrogen peroxide is introduced in an aqueous solution and in a second dosing container 330, a catalyst solution, in this case iron-III-chloride, is introduced. The second dosing container 330 is connected to the first dosing container 320 via a line 331. The catalyst solution can thus be metered from the second metering container 330 into the first metering container 320 via a metering unit not shown. In the first dosing tank 320, a catalytically accelerated decomposition of the hydrogen peroxide thus takes place, whereby oxygen is formed. This is transferred via line 321 from the first metering vessel 320, below level, to the vessel 310. Instead of catalytic decomposition in the first metering vessel 320, decomposition in the first metering vessel 320 can also be accelerated by heating.

In a first experiment, 30 kg of milled material is added to a tank with an agitator containing 40 L of water at 18° C. 4 kg of Na₂CO₃ is added to obtain sufficient density for the bitumen extract to float on the water after separation. Two tubes are connected in parallel to dispense a 35% H₂O₂ solution and a 40% FeCl₃ solution at a flow rate of 100 microliters/minute. The mixture of the two reagents generates gas bubbles even at low temperature, which are produced by the decomposition of the peroxide. After two hours, a bituminous extract weighing several kilograms is collected and dried in powder form. The remaining material consists of sand and pebbles, which are cleaned of their bitumen. Furthermore, a brown residue of oxidized iron is visible, but this can be easily rinsed out. The water temperature only rises to around 22° C. during the reaction due to the endothermic nature of the peroxide decomposition.

In another experiment, peroxide decomposition was accelerated by local heating: About 30 kg of milled material is mixed with 40 L of water at 15° C. in a reactor with a stirrer. 4 kg of Na₂CO₃ is added to obtain sufficient density for the bitumen extract to float on the water after separation. Two tubes are inserted into each other. With the inner tube, a 35% H₂O₂ solution is added to the reactor at a flow rate of 100 microliters/minute. Boiling water is added between the inner tube and the outer tube. As it exits the reactor, the mixture of hydrogen peroxide and hot water generates high temperature gas bubbles. After two hours, a bituminous extract weighing several kg is collected and dried in powder form. The remaining material consists of sand and pebbles that have been cleaned of their bitumen.

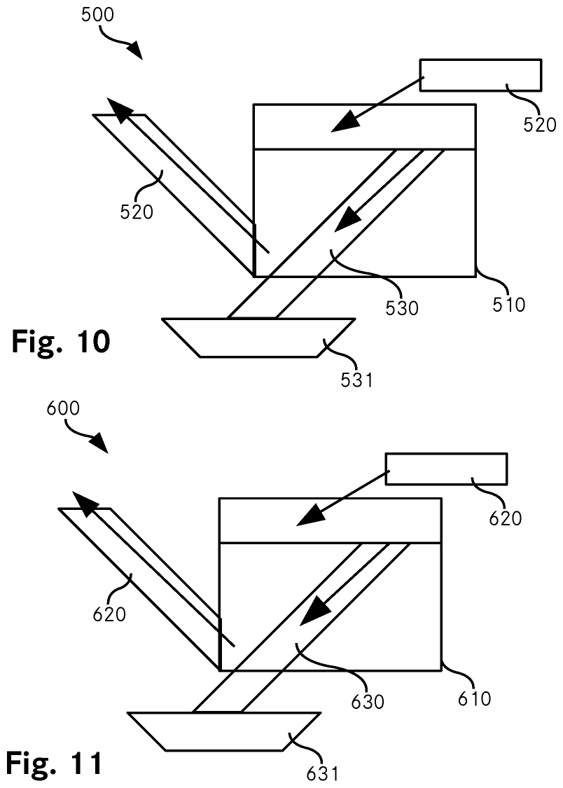

FIG. 10 shows a schematic diagram of a third embodiment of an apparatus for carrying out the process, in which the bitumen is skimmed off at the liquid surface.

At high temperatures (typically above 35° C.), the bitumen floats on the water after separation and can be separated by skimming. At low temperatures, the bitumen basically precipitates and sinks to the bottom of the reactor. Below 35° C., the bitumen has a density of about 1.03 t/m3. To achieve sufficiently efficient separation of the bitumen via the liquid surface, the density of the liquid should be, for example, 1.045 t/m3. Now, in order to achieve floating of the bitumen on the surface of the water even at low temperatures, the density of the water can be increased to or above this value by additives such as salt, sugar, suspended solids, sludge, etc. This can be achieved, for example, by adding at least 5% Na₂CO₃. Since at the same time the sand and gravel have a higher density, the bitumen can thus be effectively separated from the sand and gravel at low temperature and simply skimmed off at the water surface.

FIG. 10 shows a device 500 with which this process can be carried out. The milled material is fed into the reactor 510 by a conveyor 520. The reactor 510 contains an aqueous solution with 5% Na₂CO₃. The process temperature is 20° C. Thus, the bitumen in the milled material has a lower density than the liquid and thus floats on the liquid after separation from the sand/gravel. The process can be supported by flotation, as described above. Depending on the intensity of the flotation, the increase in density may not be required. Sand and filler settling on the bottom of the reactor is discharged from the reactor 510 via a conduit 530.

FIG. 11 shows a schematic representation of a fourth embodiment of an apparatus for carrying out the process, wherein the bitumen is collected at the bottom of the vessel and discharged.

If the reaction is carried out in cold water (below 35° C.), it is also possible to dispense with increasing the density of the liquid. In this case, the bitumen can sink to the bottom of the 610 reactor along with the minerals (sand, gravel). The sand and gravel can be removed with a mineral-specific auger 620. The filler can be flushed out with the reagent foam via a conduit 630. The bituminous residue may be discharged from reactor 610 at the end of the separation process or by a special mechanical means (e.g., chain scraper).

In another embodiment, the separated bitumen is kept in suspension, for example by adjusting the density or by a suitable stirring method. During the process, the liquid containing the suspended bitumen is now pumped off and separated from the liquid in a separate container, for example by decanting. The separated liquid can be returned to the reactor. This allows the bitumen to be removed from the liquid in a continuous process. Sand/gravel and the filler can also be continuously removed from the liquid, for example via a mineral-specific screw conveyor. Thus, the entire process can be carried out continuously.

In another experiment, 3 tons of sands contaminated with hydrocarbons (C10-C40 (number of carbon atoms per molecule); 320 mg/kg) and total organic carbon (TOC: 8100 mg/kg) were treated in a 9000 liter tank filled with water at 80° C. and equipped with an agitator; 25 L of peroxide 35% was added below the water level and the whole was mixed for 15 minutes. After a few minutes, a foam could already be seen on the water level, containing fine material, which overflowed from the tank and was collected.

After the experiment, the sand remaining in the tank and the fine material that overflowed from the tank were analyzed:
The sands contained a hydrocarbon concentration of 170 mg/kg (C10-C40) and a TOC value of less than 5,000 mg/kg;
The fine material discharged as foam contained enriched hydrocarbons at 5,400 mg/kg and a TOC value of 110,000 mg/kg.

The analyses show that the treatment works and reduces the contamination by a factor of 2 under the above conditions, making these sands suitable for use in construction.

This shows that the process concentrates the contaminants in the fine material, which exits as foam, and significantly reduces or eliminates the contaminants on the sand.

Small scale trials have also shown that PAH contaminated soils can be cleaned using the process of the present invention. PAH-contaminated soils can originate from roadsides, but also from dust precipitation from industrial processes, such as polluted sites near aluminum plants that were operated in the past using the Sorderberg process.

In a post-treatment stage, the materials (sand, gravel, bitumen, etc.) can be rinsed to remove residues of the additives (e.g. common salt, ferric chloride, peroxide, etc.). The bitumen may be dewatered, in particular, for example, pressed, compacted, heated.

In summary, it can be stated that, according to the invention, a process for separating bituminous material from a secondary raw material is created, which can be carried out particularly effectively and with little effort.

Since the devices and methods described in detail above are examples of embodiments, they can be modified to a wide extent by the skilled person in the usual manner without departing from the scope of the invention. In particular, the mechanical arrangements and the proportions of the individual elements with respect to each other are merely exemplary. Some preferred embodiments of the apparatus according to the invention have been disclosed above. The invention is not limited to the solutions explained above, but the innovative solutions can be applied in different ways within the limits set out by the claims.

1. A method of processing bituminous road surfacing material from a road demolition, the bituminous road surfacing material being in the form of at least one of break out material and milled material, the method comprising the steps of:
mixing the bituminous road surfacing material with water to form a mixture; and
adding at least one of a peroxide and a bicarbonate or at least one of hydrogen peroxide and bicarbonate to at least one of the water and the mixture.

2. The method according to claim 1, wherein the addition of the at least one of the hydrogen peroxide and the bicarbonate is controlled such that conglomerates of the bituminous road surfacing material are disaggregated.

3. The method according to claim 1, wherein the addition of the at least one of the hydrogen peroxide and the bicarbonate is carried out below level.

4. The method according to claim 1, further comprising the steps of mixing the bituminous road surfacing material unprocessed, directly with water to form a mixture.

5. The method according to claim 1, further comprising the steps of heating the mixture or heating the mixture to a temperature above 50° C. or heating the mixture to a temperature above 60° C.

6. The method according to claim 1, further comprising the steps of mechanically processing the mixture.

7. The method according to claim 1, wherein:
the bituminous road surfacing material comprises grit, sand, filler and bituminous material, and
the method is carried out until at least one of at least 80%, at least 90% and at least 95% of the grit is separated from the bituminous road surfacing material.

8. The method according to claim 1, wherein the method is carried out until a residual amount of bituminous material adhering to at least one of the grit and the grit, sand and filler is less than at least one of 3% by weight, less than 1% by weight, and less than 0.3% by weight.

9. The method according to claim 1, further comprising the step of collecting the bituminous material at a liquid surface of the mixture.

10. The method according to claim 1, wherein the bituminous road surfacing material further comprises at least partly bituminous material with a penetration value of at least one of less than 25, less than 20, and less than 15.

11. The method according to claim 1, wherein at least one of at least 30% by weight, least 50% by weight, and at least 75% by weight of the bituminous road surfacing material comprises a conglomerate size of more than 5 cm when mixed with the water.

12. The method according to claim 1, wherein a difference in density between the bituminous material floating on the surface and the mixture is increased by adding at least one first substance which influences the density, the first substance comprising at least one of an alkali, an acid, a salt and constituents of road surfacing material.

13. The method according to claim 1, wherein the bituminous road surfacing material comprises binders for achieving a bond between bituminous material and gravel, the binders comprising at least one of polymers, preferably styrene-butadiene-styrene amide esters.

14. The method according to any claim 1, wherein an adhesion between the bituminous material and the gravel of the bituminous road surfacing material is between 70% and 80%.

15. The method according to claim 1, wherein a proportion of VOC in the bituminous material is less than at least one of 1% by weight, 0.5% by weight, and 0.1% by weight.

16. (canceled)

17. The method according to claim 9, wherein the step of collecting is performed by means of flotation.
